(19) United States
(12) Patent Application Publication
(10) Pub. No.: US 2010/0162260 A1
(43) Pub. Date: Jun. 24, 2010

(54) Data Processing Apparatus

(75) Inventor: Abdul Hafiz Ibrahim, St. Peter Port (GB)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: VEDA Technology Limited, St. Helier (GB)

(21) Appl. No.: 12/465,487

(22) Filed: May 13, 2009

(30) Foreign Application Priority Data
Dec. 18, 2008 (GB) 0823187.0

(51) Int. Cl. G06F 9/46; G06F 9/44; G06F 9/45

(52) U.S. Cl. 718/105; 719/315; 717/116; 717/140

(57) ABSTRACT

A method of providing a service application on a data processing apparatus comprising an interconnect and a plurality of data processing nodes, the method comprising the steps of, registering a service class at the interconnect, the service class having an associated service descriptor, generating a service object at a data processing node, the service object comprising an instance of the service class, and storing subscription information at the interconnect to permit messages to be routed to the service object in accordance with the service descriptor.

### BACKGROUND TO THE INVENTION

This invention relates to a method of providing a service application on a data processing apparatus, a method of routing messages on a data processing apparatus, an interconnect for the data processing apparatus, a data processing network including an interconnect and operable to perform one or more of the methods, a development environment and an execution environment.

### DESCRIPTION OF THE PRIOR ART

It is known to provide a group of microprocessors or computers which are interconnected to share processing. The term ‘cluster’ is generally used to refer to a group of computers that are interconnected. Clusters or other groups of processors are advantageous in that the capacity of the system to handle processing demands is increased and can be simply improved by adding additional processors or nodes. Such a system also provides a fault tolerant environment where the loss of a single processor should not prevent an application from running. Finally, high performance can be achieved by distributing work across multiple servers or processors.

There are some problems with providing groups of interconnected processors in this manner. A cluster can be complex to set up and administer and this is reflected to an extent in the fact that application for clusters often have to be written specifically for clusters and require configuration accordingly. Applications may indeed be written specifically for clusters. For example, using Beowulf it is necessary to decide which part of a program can be run simultaneously on separate processors. Appropriate controls are then set up to run the necessary simultaneous parts of the application.

Another approach may be encountered in Internet applications, where a cluster has a number of distinct servers, and requests are directed to a master server which distributes loads between the various servers. It is known to use various techniques for load balancing, such as simply allocating work to each server in turn, or may take into account the capacity and status of each server. However, the techniques used in Internet servers in this manner are not necessarily directly applicable to other clusters or processor networks.

Further, it is known to provide multiple cores in a processor, where the issue of distributing work similarly applies.

The most common approach to taking advantage of multiple processors is a technique known as ‘multi-threading’. Programming languages require little or no syntactic changes to support threads, and operating systems and architectures have evolved efficiently to support threads. Most application software however is not written to use multiple concurrent threads intensively because of the challenge of doing so. Frequently in multi-threaded application design, a single thread is used to do the intensive work, while other threads do much less. A multi-core architecture is of little benefit if a single thread has to do all the intensive work due to the application designs inability to balance the work evenly across multiple cores.

Writing truly multi-threaded software often requires complex co-ordination of threads and can easily introduce subtle and difficult-to-find bugs due to the interleaving of processing on data shared between threads. Consequently, such software is much more difficult to debug than single-threaded applications when a software design fault is discovered.

Another popular approach to concurrent software design is to take what is essentially a sequential software application, and to identify any significant amounts of computation that take place within any loops or arrays. This identification of loop/array parallelisation candidates may be automatic or explicit. The parallelisation framework then transparently arranges for these highly symmetrical workloads to be executed concurrently.

Super-computing communities tend to favour explicit management of concurrent processes which communicate using message passing techniques such as MPI. This technique often yields good performance, but requires very high levels of programmer skill and effort.

A general problem which is not solved by any of the above solutions is that of providing a flexible and easily adaptable application or service which can operate across a number of data processing nodes in a non application-specific manner. It is known for systems to handle both the application logic relating to the service itself and also the deployment logic relating to the deployment of the service, leading to a system that may be difficult to scale or not easy to set up or administer. An attempt to provide a scaleable computing system for executing applications across a data processing network is shown in US Patent Application No. US2006/0143350. This document teaches providing a grid switch operable to address a plurality of separate data processing nodes, where the grid switch allocates resources in a plurality of nodes in response to a service request, and provides for control of the grids on the individual data processing nodes and allocation of resources to a service depending on availability of the nodes. The system thus separates the server processes from the switching requirements.

This does somehow still require the grid switch to be set up to receive further messages bearing an identified address and routing the responses to that address.

An aim of the invention is to reduce or overcome one or more of the above problems.

### SUMMARY OF THE INVENTION

According to a first aspect of the present invention, we provide a method of providing a service application on a data processing apparatus comprising an interconnect and a plurality of data processing nodes, the method comprising the steps of, registering a service class at the interconnect, the service class having an associated service descriptor, generating a service object at a data processing node, the service object comprising an instance of the service class, and storing subscription information at the interconnect to permit messages to be routed to the service object in accordance with the service descriptor.

A plurality of service objects may be generated at a plurality of data processing nodes.

The subscription information may comprise domain descriptor information identifying the service objects belonging to a domain and a distribution policy associated with the domain.

The distribution policy may comprise a load balancing policy, and the method may comprise the steps of generating a job identifier for a transaction and associating the job identifier with an identifier of a service object performing the transaction.

The method may comprise receiving a message, reading the published message and identifying one or more of the data processing nodes as a recipient in accordance with the subscription information, and, routing the message to one or more of the data processing nodes in accordance with the distribution policy.

According to a second aspect of the invention, we provide a method of routing messages on a data processing apparatus which may comprise an interconnect and a plurality of data processing nodes, the method may comprise the steps of, registering subscription information associated with a service class at the interconnect, the subscription information identifying a set of data processing nodes and a distribution policy, receiving a published message, reading the published message and identifying the set as a recipient in accordance with the subscription information, and routing the message to one or more of the data processing nodes in accordance with the distribution policy.

The step of comparing a message with the subscription criteria may comprise reading a header of the message, the header may comprise message classification information, and forwarding the message to one or more of the processing nodes where the message classification information is in accordance with the subscription criteria associated with the one or more nodes.

The message classification information may comprise an indication of the message content.

The message classification information may comprise a session identifier.

The interconnection element may be operable to receive a session identifier request from a processing node, supply a session identifier to the processing node and store the session identifier associated with the node identifier.

The step of forwarding a message may comprise sending the message to an input queue of the or each processing node.

The subscription information may comprise information identifying a domain, the interconnection element being operable to store domain descriptor information identifying one or more members belonging to the domain and distribution policy associated with the domain, wherein a message which is in accordance with the subscription information is forwarded at least one of the one or more processing nodes in accordance with the distribution policy.

The domain descriptor information may identify one or more domains, wherein the message is forwarded at least one node in the one or more domains in accordance with a distribution policy associated with the one or more domains.

The distribution policy may distribute the messages on a load balancing basis.

The distribution policy may distribute the messages on a quality of service basis.

The distribution policy may distribute the messages on a mirroring basis such that the message is sent to all members of the domain.

The step of receiving a published message may comprise receiving the message from an output queue of a data processing node.

The method may comprise initial steps of providing a service application by registering a service class at the interconnect, the service class having an associated service descriptor, generating a service object at a data processing node, the service object comprising an instance of the service class, and storing subscription information at the interconnect to permit messages to be routed to the service object in accordance with the service descriptor.

According to a third aspect of the invention, we provide an interconnect for a data processing apparatus, the interconnect being operable to communicate with a plurality of data processing nodes of the data processing apparatus, the interconnect being operable to register a service class, the service class having an associated service descriptor, generate a service object at a data processing node, the service object comprising an instance of the service class, and store subscription information at the interconnect to permit messages to be routed to the service object in accordance with the service descriptor.

According to a fourth aspect of the invention, we provide an interconnect for a data processing apparatus, the interconnect being operable to communicate with a plurality of data processing nodes of the data processing apparatus, the interconnect being operable to register subscription information at the interconnect, the subscription information identifying a set of data processing nodes and a distribution policy, receive a published message, read the published message and identify the set as a recipient in accordance with the subscription information, and, route the message to one or more of the data processing nodes in accordance with the distribution policy.

The interconnect may be operable to route the message to a data processing node by placing the message in an input queue of the data processing node.

According to a fifth aspect of the invention, we provide a data network comprising an interconnect according to the third or fourth aspect of the invention and a plurality of data processing nodes.

The data processing apparatus may be operable to perform a method according to the first or second aspects of the invention.

According to a sixth aspect of the invention, we provide an integrated development environment for designing, developing and maintaining concurrent software applications, the integrated development environment comprising a plurality of information editors, each editor being operable to create, modify and destroy at least one information set of user specified information elements, each editor having at least one user interface, the plurality of information editors comprising:
(1) a state machine model editor that is operable to create, modify and destroy at least one state machine model information set, each state machine model information set comprising information elements comprising;
   (a) a set of states the state machine model may exist in;
   (b) a reset state attribute indicating which state an instance of the state machine model should enter whenever the instance is initialised or reinitialised, and
   (c) a load balance policy attribute specifying the load balancing policy that is to be applied by an execution environment when creating instances of the state machine model and in routing of messages to those instances;
(2) a subroutine editor that is operable to create, modify and destroy at least one subroutine information set, each subroutine information set comprising information elements comprising programming language statements that represent a subroutine and any associated definitions;
(3) a subroutine list editor that is operable to create, modify and destroy at least one subroutine list information set, each subroutine list information set comprising information elements comprising an ordered list of at least one element, with each element comprising a subroutine;
(4) a trigger condition editor that is operable to create, modify and destroy at least one trigger condition information set, each trigger condition information set comprising information element comprising
   (a) a state machine model;
   (b) an expression defining a trigger condition, and
   (c) a subroutine list, and;
(5) a subscription editor that is operable to create, modify and destroy at least one subscription information set, each subscription information set comprising the information elements:
   (a) at least one subscription specification consistent with a publish/subscribe messaging subscription model, and;
   (b) a state machine model.

According to a seventh aspect of the invention, we provide an execution environment for deploying concurrent software applications generated by an integrated development environment according to the first aspect of the invention, the execution environment comprising:
(1) at least one data processing node each being operable to:
   (a) load a plurality of information sets generated by the integrated development environment, the plurality of information sets comprising one or more;
      (i) state machine model information sets,
      (ii) subroutine information sets,
      (iii) subroutine list information sets,
      (iv) trigger condition information sets, and
      (v) subscription information sets;
   (b) create at least one instance of a loaded state machine model information set, each instance being implemented within a processing context, each state machine model information set instance comprising:
      (i) run-time representation of the programming language statements of each subroutine information set specified by a subroutine list information element of a trigger condition information set, where the trigger condition information set has a state machine model information element specifying the state machine model information set from which the state machine model information set instance is derived;
      (ii) at least one static variable representing the current state of the state machine model information set instance, and being initialised to indicate the state represented by the reset state attribute associated with the state machine model information set from which the state machine model information set instance is derived, the initialisation occurring when the instance is first created and repeated each time the instance is restarted;
      (iii) static variables representing the global variables associated with the state machine model information set such that they are intended to be hosted by instances of the state machine model information set;
      (iv) local variables, associated with the subroutine information sets associated with the state machine model information set, being dynamically created and destroyed in a manner understood within the art for temporary variables;
   (c) provide the executable code of each state machine model information set instance dynamic access to allocation and deallocation of and interaction with execution environment resources including system and library services, through an application binary interface (ABI);
   (d) provide an ABI service to allow a current state of a state machine model information set instance to be changed to a new nominated current state;
   (e) provide an ABI to access the services of a publish/subscribe messaging subsystem;
(2) a data communications network that is operable to allow data communications between data processing nodes connected to the data communications network;
(3) a Publish/Subscribe messaging subsystem being operable to:
   (a) implement a publish/subscribe messaging service and support registration of subscriptions and publication and notification of messages by software applications deployed in the execution environment;
   (b) register as subscriptions with the publish/subscribe messaging subsystem, all subscription specifications contained in all loaded subscription information sets associated with an application, with each subscription specification being registered on behalf of any state machine model information set subscribers specified in the subscription information set containing the subscription specification;
   (c) forward notification messages/events received by a state machine model information set resulting from registration of subscription specifications of a subscription information set on behalf of that state machine model information set, to a load balancer subsystem which implements a load balancing policy specified by the load balance policy attribute of the state machine model information set, and eventually to at least one instance of the state machine model information set selected by the load balance subsystem;
   (d) execute the list of subroutine information sets specified by a subroutine list information element of a trigger condition information set,
(4) a load balancer subsystem, the load balancer subsystem being operable to receive notifications generated by subscription information sets registered with the publish/subscribe messaging subsystem which specify a state machine model information set as the subscriber, and to direct each received notification to at least one specific active instance of the subscribing state machine model information set in accordance with a load-balancing policy where each active instance of the state machine model information set has been created by a data processing node under the direction of the load-balancer.

### BRIEF DESCRIPTION OF THE DRAWINGS

An embodiment of the present invention will now be described by way of example only with reference to the accompanying drawings wherein:

FIG. 1 is a diagrammatic illustration of an interconnect element and a plurality of processing nodes embodying the present invention,

FIG. 2 is a diagrammatic illustration of another embodiment of an interconnect element and a plurality of processing nodes,

FIG. 3 is an illustration of a service application

FIG. 4 is a illustration of a method of launching a service application,

FIG. 5 is an illustration of a further configuration of interconnection element and data processing nodes embodying the present invention,

FIG. 6 is an illustration of a processing node of the embodiment of FIG. 2,

FIG. 7 is an illustration of a service descriptor,

FIG. 8 shows a flow chart for a method of routing messages in accordance with the present invention, and

FIG. 9 is an illustration of a example scheme for partitioning data processing nodes.

### DESCRIPTION OF THE PREFERRED EMBODIMENT

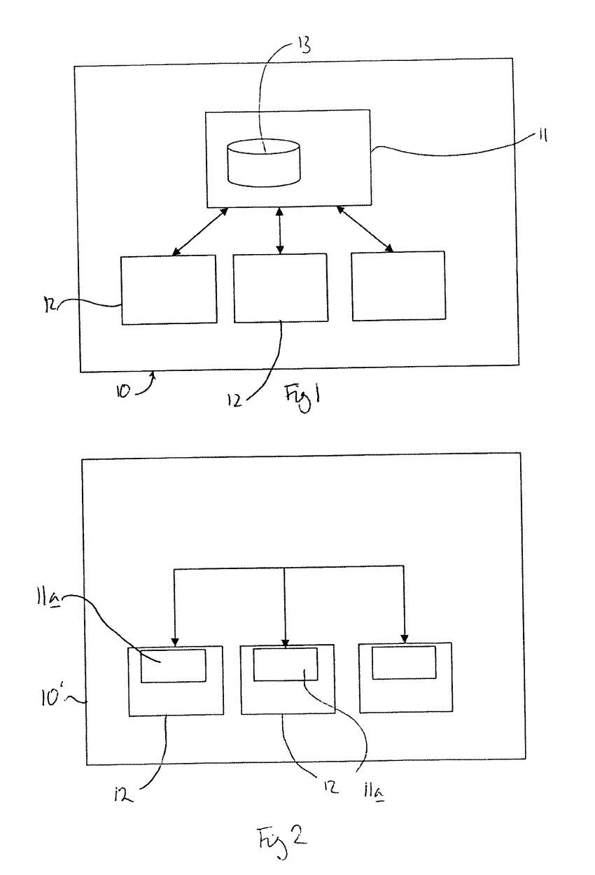

Referring now to FIG. 1, a data processing apparatus is generally shown at 10. In this illustration, the data processing apparatus includes an interconnection element 11 and a plurality of data processing nodes 12. The data processing apparatus 10 and the associated interconnection element 11 and data processing nodes 12 may be provided in any appropriate fashion as desired. For example it may be envisaged that the interconnect element 11 and data processing nodes 12 are provided on one or more microprocessors using hard wired digital logic. The interconnection element 11 or processing nodes 12 may alternatively be provided as multiple processes run by a microprocessor, or as part of a multi-core processor, or may be distributed across multiple processors or operating on multiple virtual processors in a single physical core. The underlying physical processing apparatus clearly may be provided as desired, for example as firmware or embedded logic, a programmable logic array, ASIC, VLSI or otherwise. The nodes may communicate using TCP/IP or any other protocol appropriate to the interconnection element 11. Each node has a unique identifier, referred to as its NODE_ID.

In one example, each of the data processing nodes is operable to host one or more processing contexts, under the control of a multi-tasking operating system kernel, where each context is a separate thread or process. The kernel is operable in conventional manner to schedule execution of the processing contexts across the or each microprocessor available at the processing node 12, so that each processing context receives an amount of processing time and thus giving the impression that the node 12 is executing a plurality of processing contexts simultaneously. The nodes 12 do not have to be equivalent and may be of different processor types and resource capabilities.

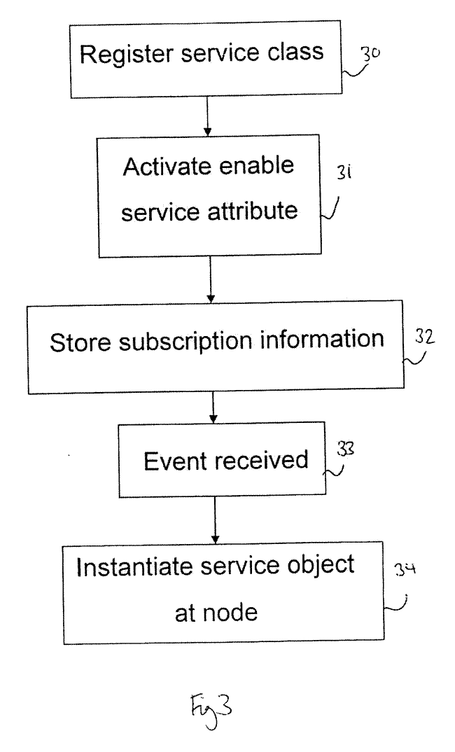

In an alternative embodiment as illustrated at 10′ in FIG. 2, the interconnection element may be provided distributed across the processing nodes 12. As described in more detail below, each processing node 12 has a protocol stack 11a which mediates all communications between the processing node 12 and other nodes provided on the network.

However implemented, the data processing apparatus 10 is operable to provide a service, that is to run a particular application. Each of the data processing nodes 12 is operable to perform one or more processing steps as required by the service.

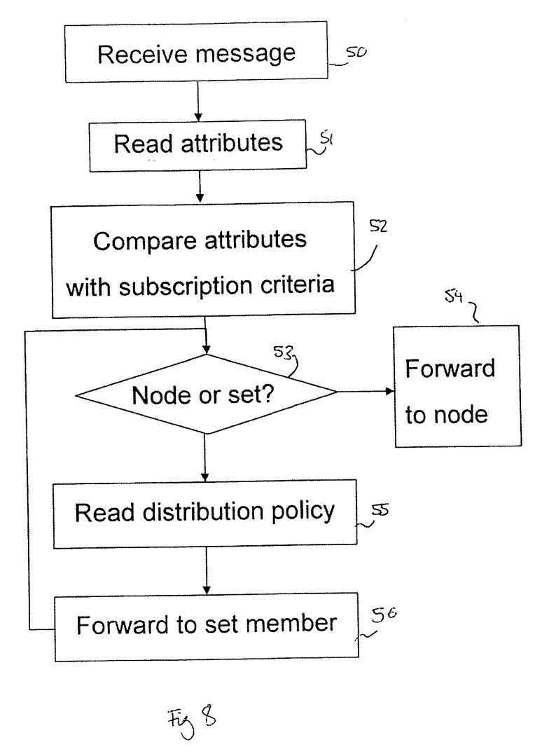

It will be apparent that, where a group of data processing nodes 12 and an interconnection element 11 provide a particular application or service, it is necessary to group the various nodes to provide for appropriate routing of messages and to permit load balancing and quality of service control amongst other considerations. Ideally the service description or configuration should be independent of each of the processing steps or application logic performed by the various processing nodes. A group of nodes forming sets and subsets is shown in more detail in FIG. 7 and discussed below.

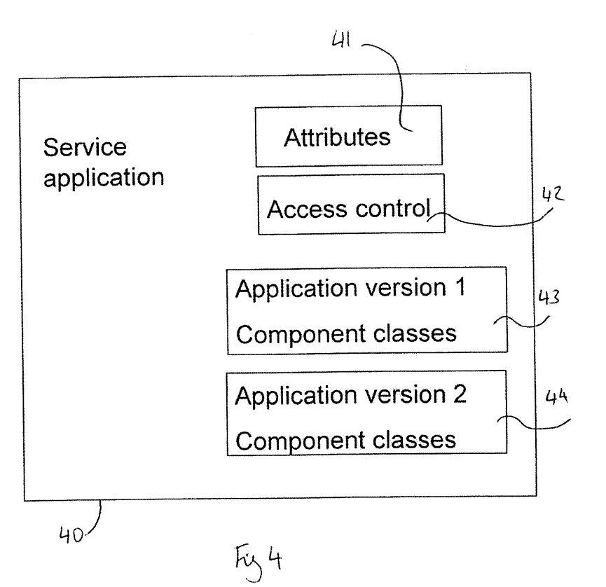

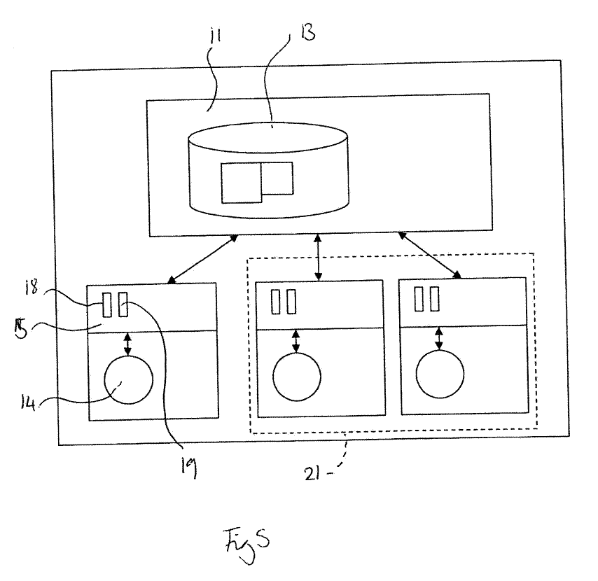

The steps needed to provide a service over the network 10, 10′, are shown in FIG. 3. At step 30 a service application 40 is registered at the interconnection element 11 and stored on the store 13. The service application 40 holds all the information required to launch and execute a desired service on the network 10, 10′. As illustrated in FIG. 4, the service application 40 comprises appropriate attributes 41 of the service application, including the name and description of the service application 40, the service category and any other desirable information. This information may be used, for example, to list the service application in a directory from which it may be selected by a service user. The access information 42 may include any access constraints on which users can use the service, for example that the user must have sufficient access privileges, or have been a user for a minimum length of time, or have used some other service first, or indeed any other criteria as desired. The access information may also include including billing information, licensing limits or other constraints such as time-limited access.

To enable the service to be launched, the service application 40 lists all the required service classes, as shown at 43. In this example, different versions of the service application are available, and so a second list of required service classes corresponding to a second version of the service is shown at 44.

Each of the service classes identified in the service application 40 has two parts. The first is the service class code, that is the programming logic that makes up the service class, together with any data declarations that are required, in like manner to the declaration of a class in conventional object oriented programming. The service class declaration will typically include declaration of ‘constructor’ and ‘destructor’ functions which may be called to start and stop instances of the service class by the interconnect. The second is the service class deployment logic. The service class deployment logic specifies on which processing nodes 12 instances of the service class may be executed, and the routing logic, defines how workload and messages are to be distributed across the processing nodes 12 as discussed in more detail below. When the service application 40 is registered with the interconnection element 11, each of the service classes identified in the service application is also registered at the interconnection element 11.

In the present example, to enable the service to be made available to a user, the service application 40 must be activated by the system administrator are shown at 31 in FIG. 3. The activation of the service application results in the activation of the service classes identified in the service application, and causes any subscriptions required by the service class to be registered at the interconnection element 11 as shown at step 32. At this stage, any resources required for operation of the service class may be allocated. Preferably, a system administrator would also be able to stop or suspend service applications or individual service classes as needed

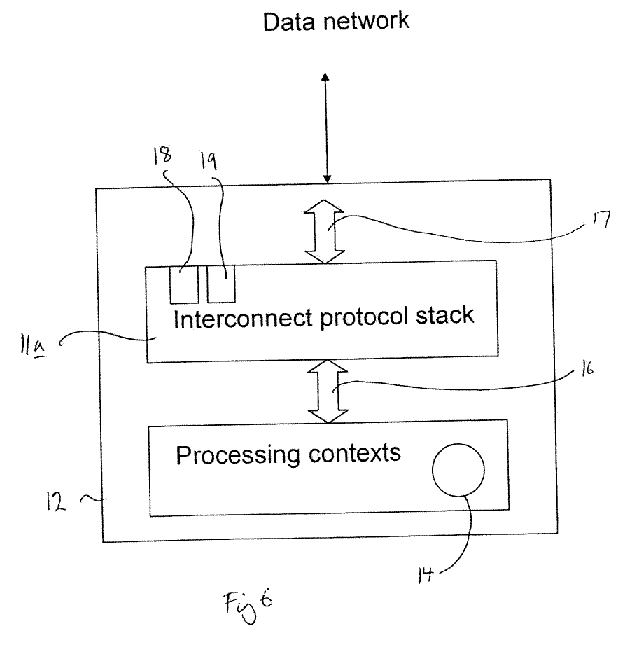

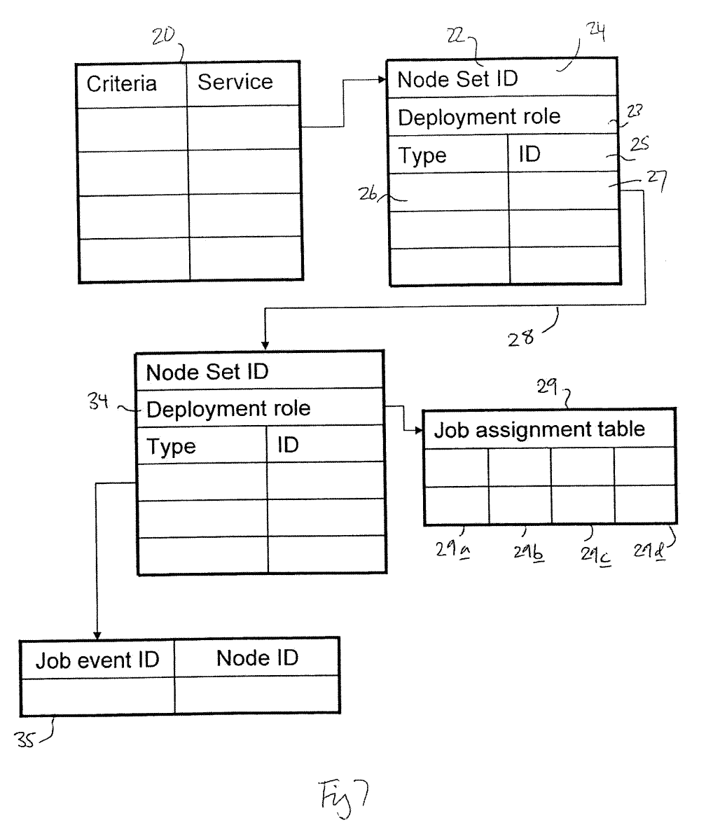

When a service is launched in accordance with a user's requests, as shown at step 32 in FIG. 3, the interconnection element 11 instantiates a service object 14 at each of a plurality of processing nodes 12 as shown at step 34. Service objects 14 are instances of the service class 40, and are hosted by appropriate process contexts in each of the data processing nodes 12. Each node 12 may host one or more service objects as desired. Although the service objects 14 are referred to as “objects” consistent with the terminology of instances of classes within the Object Oriented Programming (“OOP”) system, it will be apparent that the objects may be instances of data structures with associated subroutines, or any other active processing or program element appropriate to provide desired data processing functions. Each of the service objects 14 is operable to perform the desired service logic or application logic to be performed by the service. Each of the objects 14 interacts with the connection element 11 as appropriate. In the embodiment of FIG. 5, the node 12 interacts with the interconnection element 11 through an interconnect interface generally shown at 15, which may be implemented as member functions of a sub-class interface object if using OOP, or simply as an application programming interface (“API”), or otherwise as desired. The interface object 15 communicates with the interconnection element 11, whether through a “local” implementation, or across a network or otherwise as desired. In the alternative of FIG. 6, corresponding to the embodiment of FIG. 2 the service object 14 is executed in a processing context and communications with the interconnection element protocol stack 11a through on API 16. The interconnection element protocol stack 11a then sends messages across the data network using a suitable network protocol as illustrated at 17.

The service objects 14 may be of one of two types. They may be user service objects, which provide a user interface function, and core service objects which provide the actual service function.

To provide for routing of messaging between service objects 14 on data processing nodes 12, communications are provided by the interconnection element 11 on a publish-subscribe basis. A message received by the interconnection element 11 is routed to all relevant nodes on the basis of a subscription registered at the interconnection element 11 indicating that a subscribing processing node 12 or set of nodes wishes to receive a message matching those criteria.

A core service class first registers its subscriptions at interconnection element 11 on behalf of the service class when it is first activated, even though no service objects 14 have been created. The subscriptions are registered on behalf of the service class 14 initially on the gateway nodes of the service domain that will host the service class 14. A user service object will always register its subscriptions with the gateway node it uses to access a specific domain. The subscriptions will also be registered with the data processing node 12 on which the user service object is executing. At the user node, the subscription will be registered under the service class of which the user service objection is an instance. The master node set will have an entry added of the type SESSION_ID where the value is the session ID value of the interconnect session the user service object is using to communicate with the interconnection element 11. At a gateway node, the subscription will be registered under the service class of which the user service object is an instance. An entry will be added to the master node set which is the NODE_ID of the user node and the transaction assignment table associated with the master node set will have a link between the NODE_ID of the user node and the SESSION_ID of the interconnect session.

The subscription will simply amount to a criteria and a corresponding identifier as shown at 20 in FIG. 6. When a message is received by the interconnection element, the contents of that message, in particular the attributes, are reviewed and any service identified in a table with matching criteria receives a copy of the message.

The messages may have a number of attributes assigned by the object 14 which publishes the message, which are identifiable by the interconnection element 11. The attributes may include the protocol, the size of the message, the NODE_ID of the data processing node which generated the message, the class of the message, the SESSION_ID of the interconnect session which issued the original job request message, the result of which is the message being issued, the JOB_ID, a number issued within the context of the interconnection session identified by the SESSION_ID attribute, required if an interconnect session issues multiple jobs, or indeed a subject identifier. An attribute may be simple, indicating that it is simply specified by a value of a specific data type, or indeed could be complex in that it is made up of references to other attributes encoded within the message. The attributes can be used in accordance with any publish-subscribe system as desired. Thus, the publish-subscribe system may be group based, in which events are organised into sets of groups of channels and the subscribers receive all messages in that group or channel, a subject based system where the message includes a hierarchal subject/topic descriptor and the subscription can identify messages by the subject or topic, or indeed a contents based system where the subscription can be defined as an arbitrary query, and the subscriber receives all messages where the content matches that query.

As discussed in more detail below, when the interconnection element receives a message, the interconnection element 11 must provide further steps to transmit the message to ultimately the correct node, as the subscribing entity need not be a simple subscribing object which needs no further processing beyond notification, but rather a service class which must have an associated service class deployment logic analysed in order to select one or more distribution end points.

The interconnection element 11 views each object 14 with which it interacts as two first in first out (FIFO) queues as shown in FIGS. 5 and 6. To publish a message, a service object 14 places messages in an output queue 18 which are published by the interconnection element in the order which they are deposited. Any messages which the interconnection element 11 wishes to route to the object 14 are placed in an input queue 19 where they are processed by the object in the order in which they are received. An object 14 may be notified of a message in a synchronous or an asynchronous manner. If the object 14 is notified in an asynchronous manner, then the interconnection element 11 simply deposits the message in the input queue 19, and the responsibility falls on the object 14 to retrieve a message from the input queue 19 and process it. If on the other hand the object 14 has selected asynchronous notification, then in addition to depositing the message into the input queue 19, the interconnection element 11 will further initiate the execution of a predetermined function defined as a part of the object 14 (a “call-back” function) which will then be responsible for retrieving the message from the input queue 19 and processing it.

When the interconnection element has received a message published by an object 14 and placed in the message output queue 18, the interconnection element will route it in accordance with the message. Any publish-subscribe method may be used as desired, as discussed in more detail below.

To provide for correct routing of messages, the interconnection element 11 generates an identifier for a session, called a SESSION_ID. A single interconnect session is automatically created by the interconnection element for each service object 14 that is created by the interconnection element 11, and the SESSION_ID of the created session is passed as a start-up parameter to the instantiated service object 14. All messages passed by the service object 14 to the interconnection element 11, for example through the interconnect protocol stack API calls, will automatically refer to the session ID passed as a parameter to the service object 14. When the first object 14 is shut down, the interconnection element 11 will automatically free any resources allocated on behalf of the service object 14, including the session and SESSION_ID.

It is possible that a processing context can be created not through the operation of the interconnection element 11, but for example, through some user application. Such an object, which may be referred to as a generic object will create a suitable interconnection element session by sending an appropriate call to the interconnection element, for example an appropriate call to the interconnect protocol stack API. This creates an interconnect session and returns a SESSION_ID discussed above. The generic object will use this SESSION_ID for future API calls for other messages to the interconnection element 11.

To discuss the service class deployment logic in more detail, this is a data structure created by an administrator of the system 10 installed in the service class file. The data processing nodes 12 over which the administrator has authority is referred to as the service domain. In setting up the service class deployment logic, the administrator will first identify all data processing nodes 12 within the service domain and will assign one or both of the following roles to each node:
1. Gateway node: these nodes will host the service class deployment logic for all services that are to be deployed within this service domain by the administrator. Where there are multiple gateway nodes within a network, the state of the run-time deployment logic in any gateway node is reflected on every other gateway node prior to any other transaction over the interconnection element 11. The gateway nodes are responsible for any security or billing functions as specified in the access information 42 of the service application 40.
2. Core nodes: these nodes are used to host service objects 14 for service applications deployed within this domain.

In creating the deployment logic for a service class, the core nodes within the service domain are grouped into node sets for example as illustrated at 21 in FIG. 4. As illustrated at 22 in FIG. 6, the deployment logic for each node set includes a deployment role 23 which defines a functionality of that node set, including an associated routing policy as discussed below. Each node set is uniquely identified by a set identifier, SET_ID, which is assigned by the administrator. The node set is shown as a two column table 25 where the first column 23 holds the type of the node set member whose identifier is recorded in the second column 27. The type may include a SET_ID, NODE_ID or SESSION_ID, and hence a node set may point to other node sets as illustrated by arrow 28. The top level node set that ultimately references all core nodes within the service domain for a given service class 14 is called the master node set of the service class deployment logic.

In the present example, there are a number of routing policy categories some of which require routing algorithms to implement. The categories of the routing policy are;

Partitioned which routes to one or more members of a node set and requires routing algorithm;

Load balancing, which routes to one member of a node set and also requires a routing algorithm,

Paralleling which transmits messages to all members of a node set and does not require a routing algorithm;

Broadcasting, which also passes messages to all members of a node set, and

Multiplex, which sends a message to one member of the node set and similarly does not require a routing algorithm.

Where the distribution policy is load balanced, the set must also have an associated job assignment table shown at 29 in FIG. 6. This table simply records the results of any load balancing requests and records the mapping between the job event attributes and the data processing node 14 or set member that the job was assigned to. Each entry in the table has four fields, the first two fields being the job event identifier (JOB_ID) 29a and the SESSION_ID 29b and the third and fourth fields being the member type 29c and identifier 29d of the node set member which the job identifier has been assigned to by the load-balancing sub-system. It will be clear that each job only has one entry in the job assignment table.

When a message matching the subscription criteria is forwarded to a given domain or set, and the message is not a multi-cast message, then the job assignment table 29 associated with the set is scanned for an entry whose job value matches the job event attributes in the published message. If a match is found, then the set member identified in the matching table entry is notified. If no match is found, then the load-balancing sub-system is invoked to select which set member should be notified, for example in accordance with a particular load-balancing algorithm. Once the load-balancing sub-system returns a value, this is recorded in the job assignment table 29 together with the job event identifier. If the set member identified is a data processing node 14, then an instance of the subscribing service class may be created on the data processing node 12, if an object 14 is not in existence. The simplest load balancing policy may simply be to assign received messages to each member of the node set 21 in turn, and when the last member has been selected, grouping back to the first member of the node set 21 in conventional manner. It will however be apparent that any other load balancing system may be operated by the interconnection element 11 as desired.

The message being routed by the routing policy is analysed to see what partitions it is a member of. This is done by extracting a specific message attribute from the message and matching this against a partition membership database via a specified matching algorithm to establish which partitions the routed message is a member of, and to then route the message to all partitions it is found to be a member of (may be a member of more than one partition).

Routing policies that implement a ‘partitioning’ function have either a single database that holds details of all members and the partitions they are members of, or a separate database per partition, which requires dynamic assignment where each database holds details of members of the associated partition.

When a subscribed message is being analysed to see if a given partition should be notified with that message, the routing algorithm has the name of an associated message attribute registered in the service deployment logic as described earlier. This named attribute represents the messages membership details with respect to the database being analysed and is extracted from the message by the Interconnect and analysed against the database by the routing algorithm for a membership match. If a match is obtained, then the Node Set member associated with the database that was searched is notified with the message.

Where the routing policy is parallelised, the deployment attribute supplied by the service descriptor must specify all the class entry variables and their upper and lower limits allowed for any service class instants, or service object, created by the interconnection element 11. For example, where it is desired to have multiple service objects 14 operating on different input ranges, this can be specified in the service descriptor and entered in the stored description information accordingly, such that messages having the appropriate input value are routed to one of a plurality of instantiated service objects 12 so that different parts of a problem or service request can be operated on simultaneously.

Where the policy is broadcast, a received message is simply sent to all members of the domain. This may be used to provide for mirroring, where the same processing steps are performed by a number of nodes or domains, for example for redundancy or speed.

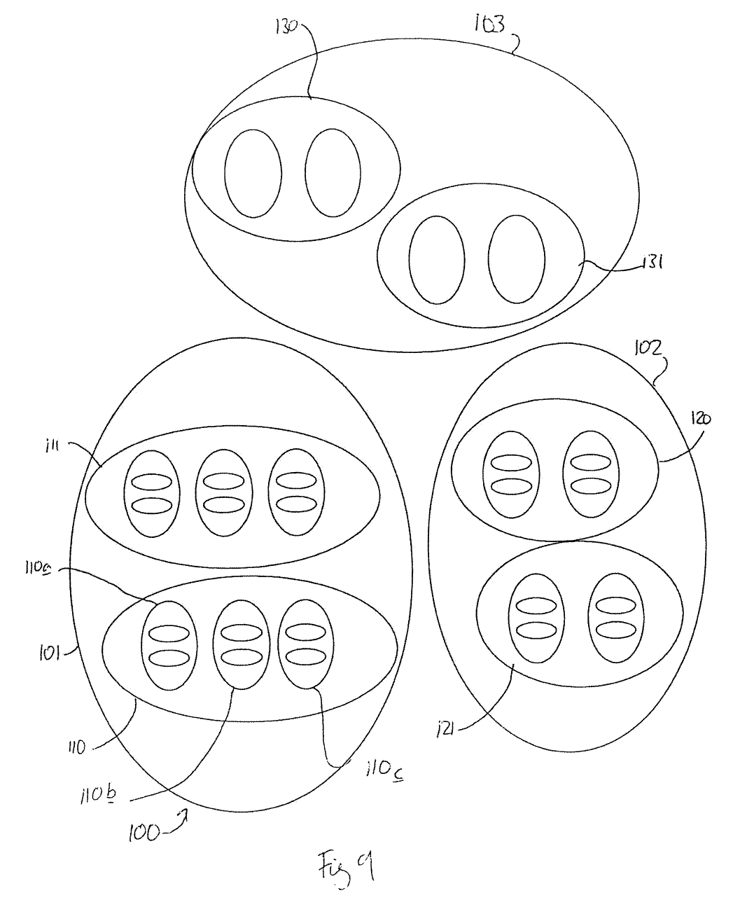

Consequently, as shown in FIG. 8 when a message is published to the interconnection element 11 at 50, it compares the message attributes field against every entry in the subscription table 20 as shown in steps 51 and 52. If a subscription is found, then the interconnection element 11 proceeds with a notification process. Where the table 24 simply identifies a data processing node 12 as identified at 53, the message can be forwarded to that node 24 as shown at 54. When the table identifies a node set the routing policy 23 corresponding to that node set is used to distribute a copy of the message as shown in step 55 of FIG. 5. The interconnection element 11 retrieves the distribution policy and selects one or more of the members of the node set to receive the message in accordance with the distribution policy as in step 35 of FIG. 3. If the distribution policy results in selecting a member that is a node set as shown at 34, then the interconnection element retrieves the routing policy for that node set 34 and uses that routing policy to find a member 35 to receive the message. The process proceeds until a node 12 is identified, and the message is sent to that node.

An example of a partition scheme formed using the invention is shown in FIG. 9. In this scheme, the available resources of the data processing apparatus are shown generally at 100 grouped into three sites 101, 102, 103. These CaO for example correspond to geographically distinct sites. This represents a top level set and the associated deployment purpose is that a message notification should be sent to one and only one member of the top level set. This may be on for example, an attribute stored within the published event which records the event membership details of a specific group, for example the address of the node where the event originated to provide a set selection based on the locality of the published message. Alternatively, the attribute could be based on subscription to some quality of service criteria or any other or indeed multiple attributes.

Each of the sites 101, 102, 103 has a subset 110, 111, 120, 121, 130, 131. Each of these subset members is provided for mirroring purposes, so the deployment purpose of the set is set to multi-task to distribute to all members so that a message is forwarded to both mirrors. In this example, each mirror set has two or three set members, 110a, 110b, 110c, for load-balancing and so the message will be distributed to one of the set members as described above. Each of the load balancing elements in this case is divided into further members and ultimately the message will be routed through the hierarchy to a service object which is operable to complete the transaction and return the result by publishing it to the interconnection element 11.

Consequently, in the system described herein, a publish and subscribe approach allows an application to be implemented as a plurality of concurrently operating but de-coupled units that can be spread over available processing nodes, whether in a cluster, a multi core environment, multi-processor or separate processors. Because an application is broken down into separate parts performed at each data processing node 12, the processes or operations performed at each processing node 12 are simple in their construction and easy to design, test and maintain as they have no dependences on any external objects. They are notified of events that are delivered to them by the interconnection element 11 and results are then simply published back to the interconnection element 11. The computational burden of re-routing and directing messages is moved to the interconnection element 11, thus reducing the load at the data processing nodes 12. The operation of the data processing apparatus 10 is thus inherently asynchronous, because a publishing data processing node 12 does not have to wait for an acknowledgement from a recipient before moving on to process the next message. Even a large application may easily be extended as amended as new data processing nodes 12 can be simply added or brought into operation, and simply require appropriate subscription criteria to be registered at the interconnection element. The newly added data processing node 12 will then be able to receive messages and return messages without needing to change or adapt the other data processing nodes 12 already in operation. Consequently, the data processing apparatus 10 enables a scaleable, load balanced and partitioned system to be developed, tested and operated in an easier manner.

An example of a development environment will now be described, in which individual service objects may be defined using a state machine model, although the objects may be defined in any other manner as appropriate.

The integrated development environment comprises a plurality of editors, including but not limited to a process model editor, a state-machine model editor, a subroutine editor, a message subscription editor and a trigger editor

The process model editor allows a user to create a process model, typically using a graphical editor. The process model created comprises of at least the names of all concurrent processes that comprise the software application being developed. Typically, each named process would also have an associated high level description of the process. A named process may have other associated attributes such as a process identifier and a physical location where the process actually takes place. Each concurrent process may itself be composed of other concurrent processes, which may themselves be composed of other concurrent processes and so on to any number of nested levels. i.e. each concurrent process may be composed of a hierarchy of concurrent processes.

A ‘leaf process’ as a concurrent process that is not made up of any other concurrent processes, but is itself the lowest level process in any process hierarchy.

The state-machine model editor allows a user to create a state-machine model for each ‘leaf process’ created using the process model editor, typically using a graphical editor.

Each state-machine model created comprises at least the names of all states that the state-machine can exist in as well as a ‘load-balance’ attribute that defines whether or not the state-machine is intended to be load balanced by the load balancer assumed to be present within the execution environment.

Each state-machine model must also have an attribute which specifies which of its component states is the active state when the state-machine is first started or reset.

If the load-balance attribute is set to a value which indicates that load balancing should take place, then the load balancer within the execution environment will create multiple concurrent instances of the state-machine based on directions from a load balancing protocol.

If the load-balance attribute is set to a value which indicates that load balancing should not take place, then the execution environment will only ever create a single running instance of the state-machine.

Typically, each named state would also have an associated high level description of the state. A named state may also have other associated attributes such as a state identifier and a state-machine enable/disable attribute.

The sequential language supported by the sequential language editor supports statements, functions or API calls that direct the state-machine whose context they are executing within to switch the active state to that specified within the language statement, function or API call.

The subroutine editor allows a user to create ‘subroutines’, typically using a text editor.

Each subroutine comprises of at least a name and a sequence of operations defined using a sequential programming language.

A subroutine may invoke other subroutines.

Typically, each subroutine would also have an associated high level description of the subroutine's purpose, as well as a subroutine identifier, entry and exit parameters, as well as a description of any system side effects.

A subroutine is only defined once, but may have multiple executable instances of it generated within the execution environment.

An executable instance of a subroutine may only exist within the context of a state-machine instance.

A subroutine is assigned to a state-machine model via registration of a ‘message subscription’.

A subroutine may be assigned to multiple state-machine models via multiple message subscriptions.

When an executable instance of a state-machine model is created within the execution environment, an executable instance of all subroutines that have been assigned to that state-machine model via message subscriptions are created within that state-machine instance, along with any subroutines invoked by the assigned subroutines.

A subroutine may declare and reference variables with local or global scope.

A variable with local scope is considered to be a temporary variable that is created when the subroutine that declares it starts to execute and is destroyed when that subroutine ends. Also it is not visible within any invoked subroutines.

A variable with global scope is considered to be a static variable that is created when the state-machine instance is created and is visible to all subroutines that are executed within the context of the state-machine instance.

Subroutines in a given state-machine instance share information with subroutines in a separate state-machine instance by sending messages to each other, as they are not able to share variables.

Subroutines interact with the state-machine environment by invoking Application Programming Interfaces (APIs).

The message subscription editor allows a user to create ‘message subscriptions’ typically using a graphical editor Each message subscription comprises at least two components:
(1) The message type being subscribed to. This defines the subject/topic or channel/group or content match criteria of messages being subscribed to according to the Publish/Subscribe messaging paradigm.
(2) The state-machine model that is the subscriber

The trigger editor allows a user to create a set of ‘triggers’ associated with each state machine model. Each trigger comprises at least 2 components:
(1) An expression, which is evaluated whenever an instance of the state machine model is notified by a message resulting from a subscription registered with the publish/subscribe messaging subsystem. The expression may contain various operands including the current state of the state machine instance, fields from the notifying message, including the message type and variables. If an expression evaluates to a boolean ‘true’ value, then its host trigger is considered to have been ‘fired’ and any subroutine list associated with the trigger is then scheduled for execution.
(2) A subroutine list, which specifies a list of subroutines that are to be executed in the event that the trigger is ‘fired’. Typically, the notifying message is passed as a parameter to the first subroutine executed.

A ‘state machine model’ node can contain the following nodes:

| Node Name | Description |
|---|---|
| states | Any states the state machine model may exist in as |
| | ‘state’ nodes. The name of each ‘state’ node is the |
| | state's ‘name’ attribute. |
| subscriptions | Any subscriptions defined for this state machine model |
| | as ‘subscription’ nodes. The name of each |
| | ‘subscription’ node is the ‘subscription name’ attribute.. |
| enter-state | Any enter-state handlers defined for this state machine |
| | model as ‘enter-state handler’ nodes. The name of |
| | each ‘enter-state handler’ node is the list of states |
| | specified in the node's attributes. |
| exit-state | Lists any exit-state handlers defined for this state |
| | machine model as ‘exit-state handler’ nodes. The name |
| | of each ‘exit-state handler’ node is the list of states |
| | specified in the node's attributes. |

Each ‘state machine model’ node has an associated ‘reset state’ attribute which indicates which of the states in the model an instance of the state machine model should enter whenever the instance is initialised.

Each ‘state machine model’ node has an associated ‘load balancing policy’ property. This may be set to the values 0 or 1 the default being 0.

A ‘load balancing policy’ of 0 indicates to the execution environment that no load balancing is to be performed, and that all jobs directed at the state machine model should be directed to a single state machine instance.

A ‘load balancing policy’ of 1 indicates to the execution environment that ‘generic’ load balancing is to be performed, and that all jobs directed at the state machine model should be load balanced based on a ‘job number’ in the notification message header and directed to a unique state machine instance for each job.

Each ‘enter-state handler’ node has the following attributes:
(1) A list of ‘states’ that the parent state machine may exist in.
(2) A list of subroutines to be executed in the order specified.
(3) An execution priority (0=highest, 127=lowest).

Whenever an instance of a state machine issues a system service request to change the state of the state machine instance to a new state, if the new state is listed in the list of states in (1) above, then the list of subroutines in (2) above is executed automatically by the system.

In the event that multiple subroutine lists become selected for simultaneous execution, they are executed in the order specified by their execution priorities in (3) above.

Each ‘exit-state handler’ node has the following attributes:
(1) A list of ‘states’ that the parent state machine may exist in.
(2) A list of subroutines to be executed in the order specified.
(3) An execution priority (0=highest, 127=lowest).

Whenever an instance of a state machine issues a system service request to change the state of the state machine instance to a new state, if the current state prior to the state change is listed in the list of states in (1) above, then the list of subroutines in (2) above is executed automatically by the system.

In the event that multiple subroutine lists become selected for simultaneous execution, they are executed in the order specified by their execution priorities in (3) above.

Each ‘process’ node has an associated ‘include’ attribute which defaults to the boolean value TRUE and which indicates whether or not the ‘process’ is to be included in the definition of the application being defined by the IDE. A value of TRUE indicates that the ‘process’ is to be included.

Each ‘state machine model’ node has an associated ‘include’ attribute which defaults to the boolean value TRUE, and which indicates whether or not the state machine model is to be included in the definition of the application being defined by the IDE. A value of TRUE indicates that the state machine model is to be included.

Each ‘state’ node has an associated ‘include’ attribute which defaults to the boolean value TRUE and which indicates whether or not the state is to be included in the definition of the application being defined by the IDE. A value of TRUE indicates that the state is to be included.

To describe the execution environment in more general terms, an execution environment’ consists of one or more data processing nodes which are connected by a data communications network.

The execution environment both hosts the integrated development environment (IDE) which generates the application as well as executes the application generated by the IDE.

The execution environment supports a data communications network service. A subroutine may invoke network services by including programming language calls to a ‘network services’ ‘application programming interface’ (API) within the subroutine source code. The ‘network services’ API supports the ‘publish/subscribe’ messaging paradigm with services to support at least the registering of message subscriptions and the publication of messages. The ‘network services’ API supports the group/channel based subscription model.

The data communications network may be an Ethernet or Infiniband network.

The network services API also supports the subject/topic based subscription model, as well as the content based subscription model. The network services API also supports message communication between all state-machines and any system external to the execution environment that is physically connected by a network and has a network protocol compatible with the network services API. Typically, a network service will support a point-to-point messaging paradigm in addition to the Publish/Subscribe paradigm.

In addition to supporting the Publish/Subscribe messaging paradigm, the messaging subsystem of the execution environment contains a load-balancer.

When a message is received by the Publish/Subscribe messaging subsystem, it is first processed to see if it has any matching subscriptions registered on behalf of any state-machine models.

A load-balancer performs load balancing on any messages that match any registered subscriptions, prior to a copy of the message being delivered to the state-machine model on whose behalf the subscription was registered.

Load balancing is done on the basis of a messaging protocol whereby a published message contains one or more header fields that specify the job or task that the message pertains to. These fields can be read and written by the publishers and subscribers of the message, and also read by the load balancer.

If the subscribing state-machine model has its ‘load-balance’ attribute set to a value which indicates that load-balancing should not take place, then a single instance of the state-machine model is initially created just prior to posting the initial message copy into its message input queue. Subsequent messages subscribed to by this state-machine model are posted to the input queue for the same state-machine instance regardless of the job/task indicated in the message header field.

If the subscribing state-machine has its ‘load-balance’ attribute set to a value which indicates that load balancing should take place, then each time a subscribed message is received by the state-machine model, a new instance of the state-machine model is created by the load balancer for each job/task instance specified in the message header field and all subsequent messages are directed to only one of these state-machine instances based on the value of the job/task in the message header field.

When a message subscribed to by a state-machine model is notified to an instance of the state-machine model, any trigger conditions associated with the state machine model are evaluated, and if any yield a boolean TRUE or numeric value greater than zero, any subroutine lists associated with the triggers are scheduled for execution.

Initially, the notification message is deposited into a ‘notification message input queue’ associated with the state-machine instance being notified by the load-balancer within the publish/subscribe messaging framework.

Each data processing node is operable to host one or more ‘processing contexts’ typically under the control of a ‘multitasking’ operating system kernel which will schedule these processing contexts for execution across the available microprocessors in a manner such that all processing contexts receive an amount of execution time based on their relative execution priority in an interleaved manner so that it creates the impression that all of the processing contexts are executing concurrently.

A ‘processing context’ is often referred to as a ‘task’, ‘process’, ‘thread’ or ‘activity’ within the context of a multitasking kernel.

All processing contexts belong to one of two categories:

### (1) Generic Objects

These are processing contexts that are created and destroyed outside of the control of the ‘Interconnect’. Generic objects are typically legacy code applications which are able to interact with the Publish/Subscribe messaging subsystem (Interconnect), but are not managed by it.

### (2) Service Objects

These are processing contexts that are created and destroyed under the control of the ‘Interconnect’. These are in fact state machine instances generated from the definition of state machine models in the application generated by the IDE.

### Service Objects

In the classical ‘object oriented programming’ (OOP) paradigm, an ‘object’ is an ‘instance’ of a ‘class’.

A processing context may implement a single OOP object, or it may implement multiple OOP objects, as the OOP paradigm does not mandate that each OOP object must be implemented within a unique processing context.

In fact, it is more normal within OOP to view an object as a set of methods (routines) that are used to manage an instance of a data structure.

A processing context is then used to manage multiple data structures through invoking their associated object methods.

The present invention comprises objects called ‘service objects’. A service object is described by the following key attributes:
(a) A service object is always implemented as an independent processing context from any other service object. Many classical or OOP objects are often implemented within the same processing context.
(b) Service objects typically communicate with other local or remote processing contexts through Publish/Subscribe network messages. Classical or OOP objects typically communicate by directly invoking each others methods, often within the same processing context rather than use any kind of messages.
(c) Service objects are typically created and destroyed under the control of a ‘Publish/Subscribe Interconnect’. Classical or OOP objects are typically created and destroyed under the control of other classical or OOP objects.

In the present embodiment, a service object is an instance of a state machine model.

In the present embodiment, the execution environment provides a ‘Publish/Subscribe’ messaging subsystem or interconnect.

A ‘publish/Subscribe interconnect’ is a distributed system that is hosted across the set of data processing nodes that are:
(1) ‘Logically’ connected to it
(2) ‘Physically’ connected to each other by a ‘data communications network’.

In this example, the publish/subscribe system works on the basis of the ‘topic’ field in published messages, i.e. it has a subject/topic based subscription model.

A Publish/Subscribe Interconnect maintains its internal state in a set of data structures that are distributed across the data processing nodes that are ‘logically’ connected to it.

The Interconnect data structures that are hosted on a given Data Processing node, together with the code that manages them and implements the Interconnect logic is collectively known as a ‘Publish/Subscribe Interconnect Protocol Stack’.

Code that is executing within a ‘processing context’ on a Data Processing Node (typically a service object), may interact with a Publish/Subscribe Interconnect by invoking a ‘Publish/Subscribe Interconnect Protocol Stack’ API (Application Programming Interface) function.

Publish/Subscribe Interconnect Protocol Stacks on different Data Processing Nodes communicate with each other using a ‘Publish/Subscribe Interconnect Network Protocol’.

A processing context must specify a ‘communication context’ when it interacts with an Interconnect Protocol Stack API to send and receive Interconnect messages.

A communication context is represented by an ‘Interconnect Session’ data structure that is located in and maintained by an Interconnect Protocol Stack and is used to manage all Interconnect messages sent and received in a specific communications context between a processing context and its local Interconnect Protocol Stack.

A processing context may simultaneously interact with multiple communication contexts. An Interconnect Session is uniquely identified within a given Interconnect Protocol Stack by a value called a SESSION_ID.

A Interconnect Protocol Stack is uniquely identified by the NODE_ID assigned to the Data Processing Node on which the Protocol Stack is hosted.

Thus an Interconnect Session is uniquely identified within a system by a combination of its SESSION_ID and the NODE_ID of its host Data Processing Node.

The primary data structures hosted within an ‘Interconnect Session’ are two FIFO (FirstIn,FirstOut) queues that are called Input Queue and Output Queue respectively.

All messages that a processing context ‘Publishes’ to an Interconnect are queued in the Output Queue of the Interconnect Session it specifies in the Protocol Stack API calls it makes in order to Publish the messages.

All messages that a processing context is ‘Notified’ of by an Interconnect are queued in the Input Queue of the Interconnect Session the processing context specifies in the Protocol Stack API calls it makes in order to retrieve any messages it may have been notified of by an Interconnect via that specific communication context.

A processing context of type ‘Generic Object’ is not created or managed by an Interconnect and as such it is fully responsible for creating, interacting with and destroying one or more Interconnect Sessions.

A Generic Object creates an Interconnect Session by issuing an ‘Open_Session’ Interconnect Protocol Stack API call. This creates an ‘Interconnect Session’ data structure and returns the SESSION_ID it assigned to it after successfully creating it. The Generic Object uses this returned SESSION_ID in all future API calls that reference this newly created Interconnect Session.

An Interconnect Session can be destroyed and all associated resources that were allocated to it freed up by the issuing of a ‘Close_Session’ Interconnect Protocol Stack API call.

Unlike a Generic Object, a service object is created and managed by an Interconnect Protocol Stack, and is in fact an instance of a state machine model which is defined by the IDE.

A single Interconnect Session is automatically created by the Interconnect for each service object that is created by the Interconnect, and the SESSION_ID of the created Interconnect Session is passed as a start up parameter to the created service object on whose behalf the Interconnect Session was created. All Interconnect Protocol Stack API calls made by a service object automatically reference the Interconnect Session whose SESSION_ID was passed as a parameter to the service object when the service object was created.

When an Interconnect Protocol Stack shuts a service object down, it also automatically frees any resources it allocated on behalf of the service object such as the Interconnect Session that was automatically created on behalf of the service object.

The publish/subscribe interconnect supports a special type of subscriber, which is a ‘state machine model’.

These state machine models are defined in the IDE as are their associated subroutines, subscriptions and triggers

The subscriptions in the IDE that have their include field set to TRUE are automatically registered with the publish/subscribe interconnect on behalf of the subscribing state machine model.

As state machine models are not executable instances they cannot process any message notifications they may receive.

So any notifications generated by the publish/subscribe interconnect destined for a state-machine model are instead routed to a ‘load balancer’. Different state machine models may use different load balancers.

If the ‘load balancing policy’ attribute of the state-machine model is set to 0 (don't load balance) then the first time a notification message is received by the load balancer on behalf of a given state machine model, a single instance of that state machine model is created by the load balancer based on its load balancing decision of where best to place that instance.

Also, the instance has all related global variables created and initialised, including the current_state global variable which is managed by the execution environment. Additionally executable instances of the associated subroutines defined in the IDE are created.

Also, the instance is initialised to enter the state specified in the state machine models ‘reset state’ attribute, as well as calling any associated enter_state subroutines to initialise that state.

It also creates an interconnect session on behalf of that state machine instance (service object) to provide the communication framework between that state-machine instance and the publish/subscribe interconnect.

Whenever the input queue associated with the interconnect session of a state machine instance is empty and the state machine instance does not have any more code to execute, the processing context is de scheduled until there are one or more messages in the input queue.

All subsequent messages the load balancer receives on behalf of that state machine model are always routed to the input queue of the interconnect session of that state machine instance.

If the ‘load balancing policy’ attribute of the state-machine model is set to 1 (load balance), then the load balancer will create multiple instances of the state-machine model in the manner described above, and route messages to these various instances based on the job_id field of the messages being routed.

Essentially, the load balancer will create a separate state machine instance for each unique job encountered and route all messages associated with a given job to the state machine instance that was created to handle messages for that job.

The state machine instances will be distributed across various data processing nodes based on load balancer administration parameters and the policy, which may be monitoring dynamic loading of nodes to decide where to locate the instances. The instances may even be moved around dynamically.

Various policies may be applied to generate a job number. If job_id is unique across the system, then it can be used alone. If it is unique within a data processing node, then job_id must be combined with origin_id to form the job number. If it is unique with an interconnect session, then job_id must be combined with origin_id and session_id to form the job number.

When a state-machine instance (service object) has one or more notification messages in the input queue associated with its interconnect session, the execution environment schedules that state-machine instance for execution.

The state-machine instance begins execution and retrieves the next message from its input queue. For each message, the state machine instance will evaluate the condition field of all triggers defined for the state machine model in the IDE.

For each trigger that is deemed to be fired, its handler is scheduled for execution by the state machine instance. More than one handler may be simultaneously scheduled for execution. Also, enter and exit state handlers may also simultaneously become scheduled for execution during the execution of a trigger handler.

All handlers scheduled for execution are executed in an order determined by their execution priority fields, with those of a lower priority value being executed before those of a higher priority value.

During execution of a subroutine, if an API call to effect a state transition is encountered, then any exit_state handlers defined within the IDE for that state machine model and the current state are first executed, then any enter_state handlers defined within the IDE for that state machine model and the state being transitioned to are then executed. Finally, the current_state global variable within the state machine instance is adjusted to reflect the state just transitioned to, control is then returned from the ‘effect state transition’ subroutine.

Upon completing execution of all subroutines that were triggered by the arrival of the message retrieved from the input queue, the state machine instance then retrieves the next message from the input queue and repeats the above process until the queue is empty at which point it signals the operating system kernel to de schedule its processing context, and to reschedule it when at least one message is in the input queue.

It will be apparent that the present invention may be implemented in hardware, software or firmware, or in any combination thereof, and may be implemented using any appropriate programming language.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of providing a service application on a data processing apparatus comprising an interconnect and a plurality of data processing nodes, the method comprising the steps of;
registering a service class at the interconnect, the service class having an associated service descriptor,
generating a service object at a data processing node, the service object comprising an instance of the service class, and
storing subscription information at the interconnect to permit messages to be routed to the service object in accordance with the service descriptor.

2. A method according to claim 1 wherein a plurality of service objects are generated at a plurality of data processing nodes.

3. A method according to claim 2 wherein the subscription information comprises domain descriptor information identifying the service objects belonging to a domain and a distribution policy associated with the domain.

4. A method according claim 3 wherein the distribution policy comprises a load balancing policy, the method comprising the steps of generating a job identifier for a transaction and associating the job identifier with an identifier of a service object performing the transaction.

5. A method according to claim 1 comprising receiving a message,
reading the published message and identifying one or more of the data processing nodes as a recipient in accordance with the subscription information, and,
routing the message to one or more of the data processing nodes in accordance with the distribution policy.

6. A method of routing messages on a data processing apparatus comprising an interconnect and a plurality of data processing nodes, the method comprising the steps of;
registering subscription information associated with a service class at the interconnect, the service class identifying a set of data processing nodes and a distribution policy,
receiving a published message,
reading the published message and identifying the set as a recipient in accordance with the subscription information, and,
routing the message to one or more of the data processing nodes in accordance with the distribution policy.

7. A method according to claim 6 wherein the step of comparing a message with the subscription criteria comprises reading a header of the message, the header comprising message classification information, and forwarding the message to one or more of the processing nodes where the message classification information is in accordance with the subscription criteria associated with the one or more nodes.

8. A method according to claim 7 wherein the message classification information comprises an indication of the message content.

9. A method according to claim 7 wherein the message classification information comprises a session identifier.

10. A method according to claim 9 wherein the interconnection element is operable to receive a session identifier request from a processing node, supply a session identifier to the processing node and store the session identifier associated with the node identifier.

11. A method according to claim 6 wherein the step of forwarding a message comprises sending the message to an input queue of the or each processing node.

12. A method according to claim 6 wherein the subscription information comprises information identifying a domain, the interconnection element being operable to store domain descriptor information identifying one or more members belonging to the domain and distribution policy associated with the domain, wherein a message which is in accordance with the subscription information is forwarded at least one of the one or more processing nodes in accordance with the distribution policy.

13. A method according to claim 12 wherein the domain descriptor information identifies one or more domains, wherein the message is forwarded at least one node in the one or more domains in accordance with a distribution policy associated with the one or more domains.

14. A method according to claim 12 wherein the distribution policy distributes the messages on a load balancing basis.

15. A method according to claim 12 wherein the distribution policy distributes the messages on a quality of service basis.

16. A method according to claim 12 wherein the distribution policy distributes the messages on a mirroring basis such that the message is sent to all members of the domain.

17. A method according to claim 6 wherein the step of receiving a published message comprises receiving the message from an output queue of a data processing node.

18. A method according claim 6 comprising the initial steps of providing a service application by;
registering a service class at the interconnect, the service class having an associated service descriptor,
generating a service object at a data processing node, the service object comprising an instance of the service class, and
storing subscription information at the interconnect to permit messages to be routed to the service object in accordance with the service descriptor.

19. An interconnect for a data processing apparatus, the interconnect being operable to communicate with a plurality of data processing nodes of the data processing apparatus, the interconnect being operable to
registering a service class, the service class having an associated service descriptor,
generate a service object at a data processing node, the service object comprising an instance of the service class, and
store subscription information at the interconnect to permit messages to be routed to the service object in accordance with the service descriptor.

20. An interconnect for a data processing apparatus, the interconnect being operable to communicate with a plurality of data processing nodes of the data processing apparatus, the interconnect being operable to;
register subscription information at the interconnect, the subscription information identifying a set of data processing nodes and a distribution policy,
receive a published message,
read the published message and identify the set as a recipient in accordance with the subscription information, and,
route the message to one or more of the data processing nodes in accordance with the distribution policy.

21. An interconnect according to claim 20 operable to route the message to a data processing node by placing the message in an input queue of the data processing node.

22. A data processing apparatus comprising an interconnect according to claim 20 and a plurality of data processing nodes.

23. A data processing apparatus according to claim 22 operable to perform a method of providing a service application on a data processing apparatus comprising an interconnect and a plurality of data processing nodes, the method comprising the steps of;
registering a service class at the interconnect, the service class having an associated service descriptor,
generating a service object at a data processing node, the service object comprising an instance of the service class, and
storing subscription information at the interconnect to permit messages to be routed to the service object in accordance with the service descriptor.

24. An integrated development environment for designing, developing and maintaining concurrent software applications, the integrated development environment comprising a plurality of information editors, each editor being operable to create, modify and destroy at least one information set of user specified information elements, each editor having at least one user interface, the plurality of information editors comprising:
(1) a state machine model editor that is operable to create, modify and destroy at least one state machine model information set, each state machine model information set comprising information elements comprising;
(a) a set of states in which the state machine model may exist;
(b) a reset state attribute indicating which state an instance of the state machine model should enter whenever the instance is initialised or reinitialised, and
(c) a load balance policy attribute specifying the load balancing policy that is to be applied by an execution environment when creating instances of the state machine model and in routing of messages to those instances;
(2) a subroutine editor that is operable to create, modify and destroy at least one subroutine information set, each subroutine information set comprising information elements comprising programming language statements that represent a subroutine and any associated definitions;
(3) a subroutine list editor that is operable to create, modify and destroy at least one subroutine list information set, each subroutine list information set comprising information elements comprising an ordered list of at least one element, with each element comprising a subroutine;
(4) a trigger condition editor that is operable to create, modify and destroy at least one trigger condition information set, each trigger condition information set comprising information elements comprising
(a) a state machine model;
(b) an expression defining a trigger condition, and
(c) a subroutine list; and;
(5) a subscription editor that is operable to create, modify and destroy at least one subscription information set, each subscription information set comprising the information elements:
(a) at least one subscription specification consistent with a publish/subscribe messaging subscription model, and:
(b) a state machine model.

25. An integrated development environment according to claim 24, wherein a state machine model information set generated by the state machine model further comprises an enter-state information element, comprising:
(1) a set of states of the state machine model;
(2) a subroutine list.

26. An integrated development environment according to claim 25, wherein the state machine model information set comprises a plurality of enter-state information elements.

27. An integrated development environment according to claim 24 wherein the state machine model information set generated by the state machine model further comprises an exit-state information element, comprising:
(1) a set of states of the state machine model;
(2) a subroutine list.

28. An integrated development environment according to claim 27, wherein the state machine model information set comprises a plurality of enter-state information elements.

29. An integrated development environment according to claim 24 wherein the state machine model information set generated by the state machine model is represented by a class, an instance of a state machine model is represented by object, attributes of a state machine model are represented by class variables, and state machine instance variables are represented by class instance variables.

30. An integrated development environment according to claim 24 wherein the state machine model editor is operable to generate a state machine model information set by causing a script that describes a state machine model to be compiled by a state machine compiler, causing the script to be converted to implementation code of a state machine.

31. An integrated development environment according to claim 24 wherein the scope of a variable referenced within a subroutine information set generated by the subroutine editor are selected from the group of scope types consisting of local and global, with a local scope variable only being addressable from within the subroutine information set containing the declaration of the local variable, and a global scope variable only being addressable from within the subroutine information set that is specified as an element of a subroutine list information element of a trigger condition information set where the trigger condition information set has a state machine model information element that specifies a state machine model information set which is intended as the host of the global variable.

32. An integrated development environment according to claim 24 wherein a programming language statement of a subroutine information set generated by the subroutine editor is operable to execute operating system services and library services as is understood within the art.

33. An integrated development environment according to claim 24 wherein a subroutine information set generated by the subroutine editor additionally comprises an entry parameter representing a notification message generated by a publish/subscribe messaging subsystem in the execution environment, whose receipt by an instance of a state machine model information set, causes the execution of the subroutine described in the subroutine information set to be triggered.

34. An integrated development environment according to claim 24 wherein when a message is specified as a parameter by a programming language statement of a subroutine information set generated by the subroutine editor, the statement invokes a service of a publish/subscribe messaging subsystem library in order to publish the message, the message having a header containing at least one field specifying a job number which may be used by a load balancer in an execution environment to perform its load balancing function.

35. An integrated development environment according to claim 24 wherein a subroutine information set generated by the subroutine editor is represented by a class method.

36. An integrated development environment according to claim 24 wherein a subroutine list information set generated by the subroutine list editor further comprises an execution priority information element, indicating the execution priority of the subroutine list information set relative to other subroutine list information sets.

37. An integrated development environment according to claim 24 additionally comprising a process model editor that is operable to create, modify and destroy at least one process model information set, each process model information set itself being comprised of zero or more process model information sets, and each state machine model information set being associated with a process model information set that is not itself composed of any other process model information sets.

38. An integrated development environment according to claim 24 additionally comprising a data model editor that is operable to create, modify and destroy at least one data model information set that may be used to construct an entity relationship diagram.

39. An integrated development environment according to claim 38 wherein the scope of a variable referenced within a subroutine information set generated by the subroutine editor are selected from the group of scope types consisting of local and global, with a local scope variable only being addressable from within the subroutine information set containing the declaration of the local variable, and a global scope variable only being addressable from within the subroutine information set that is specified as an element of a subroutine list information element of a trigger condition information set where the trigger condition information set has a state machine model information element that specifies a state machine model information set which is intended as the host of the global variable and wherein a variable having local or global scope additionally has a data type specified as the name of an entity defined within the data model information set with an instance of the variable comprising fields which are the same name and type as the fields that comprise the entity.

40. An integrated development environment according to claim 24 wherein the user interface of each editor comprises one or more of a graphical user interface, a text editor user interface, a command line user interface and an interactive voice response user interface.

41. An integrated development environment according to claim 24 wherein the expression defining a trigger condition comprising operands, operations and precedence brackets combined in a manner understood within the art, evaluating to a boolean or numeric value, with the type of each operand being selected from the group of operand types consisting of
(i) a current state variable of a state machine instance,
(ii) a global variable of a state machine instance,
(iii) a field within a notification message generated by a publish/subscribe subsystem,
(iv) a constant,
(v) the result of an operation, and
(vi) the result of a function;
and the type of each operation being selected from the group operation types consisting of:
(i) an algebraic operation,
(ii) a boolean operation,
(iii) an inequality operation,
(iv) a mathematical function, and
(v) a function implemented as a subroutine.

42. An integrated development environment according to claim 24 wherein the subroutine list comprises one of an explicitly specified subroutine list, an explicitly omitted subroutine list so that there is no specified subroutine list, and an implied subroutine list, such that in the absence of any specified subroutine list, a subroutine list nominated as a ‘default list’ is assumed to be the specified subroutine list

43. An execution environment for deploying concurrent software applications generated by an integrated development environment according to claim 24, the execution environment comprising:
(1) at least one data processing node each being operable to:
(a) load a plurality of information sets generated by the integrated development environment, the plurality of information sets comprising one or more;
(i) state machine model information sets,
(ii) subroutine information sets,
(iii) subroutine list information sets,
(iv) trigger condition information sets, and
(v) subscription information sets;
(b) create at least one instance of a loaded state machine model information set, each instance being implemented within a processing context, each state machine model information set instance comprising:
(i) run-time representation of the programming language statements of each subroutine information set specified by a subroutine list information element of a trigger condition information set, where the trigger condition information set has a state machine model information element specifying the state machine model information set from which the state machine model information set instance is derived;
(ii) at least one static variable representing the current state of the state machine model information set instance, and being initialised to indicate the state represented by the reset state attribute associated with the state machine model information set from which the state machine model information set instance is derived, the initialisation occurring when the instance is first created and repeated each time the instance is restarted;
(iii) static variables representing the global variables associated with the state machine model information set such that they are intended to be hosted by instances of the state machine model information set;
(iv) local variables, associated with the subroutine information sets associated with the state machine model information set, being dynamically created and destroyed in a manner understood within the art for temporary variables;
(c) provide the executable code of each state machine model information set instance dynamic access to allocation and deallocation of and interaction with execution environment resources including system and library services, through an application binary interface (ABI);
(d) provide an ABI service to allow a current state of a state machine model information set instance to be changed to a new nominated current state;
(e) provide an ABI to access the services of a publish/subscribe messaging subsystem;
(2) a data communications network that is operable to allow data communications between data processing nodes connected to the data communications network;
(3) a Publish/Subscribe messaging subsystem being operable to:
(a) implement a publish/subscribe messaging service and support registration of subscriptions and publication and notification of messages by software applications deployed in the execution environment;
(b) register as subscriptions with the publish/subscribe messaging subsystem, all subscription specifications contained in all loaded subscription information sets associated with an application, with each subscription specification being registered on behalf of any state machine model information set subscribers specified in the subscription information set containing the subscription specification;
(c) forward notification messages/events received by a state machine model information set resulting from registration of subscription specifications of a subscription information set on behalf of that state machine model information set, to a load balancer subsystem which implements a load balancing policy specified by the load balance policy attribute of the state machine model information set, and eventually to at least one instance of the state machine model information set selected by the load balance subsystem;
(d) execute the list of subroutine information sets specified by a subroutine list information element of a trigger condition information set,
(4) a load balancer subsystem, the load balancer subsystem being operable to receive notifications generated by subscription information sets registered with the publish/subscribe messaging subsystem which specify a state machine model information set as the subscriber, and to direct each received notification to at least one specific active instance of the subscribing state machine model information set in accordance with a load-balancing policy where each active instance of the state machine model information set has been created by a data processing node under the direction of the load-balancer.

44. An execution environment according to claim 43 where each subroutine information set to be executed is specified as a list element of the subroutine list information element of the trigger condition information set, and is executed in the order the list element occurs in the subroutine list information element.

45. An execution environment according to claim 44 wherein the subroutine information set is executed when a notification event is received by a state machine model information set instance, whose state machine model information set from which the instance is derived is specified in the state machine model information element of the trigger condition information set, and additionally when the expression information element of the trigger condition information is in accordance with the trigger condition.

46. An execution environment according to claim 43 additionally comprising a data model editor that is operable to create, modify and destroy at least one data model information set that may be used to construct an entity relationship diagram wherein the data processing node is additionally being operable to load a data model information set.

47. An execution environment according to claim 43 wherein an ABI service of a data processing node is operable to change the current state of a state machine model information set instance to a new nominated current state and is operable to execute the list of subroutine information sets specified by a subroutine list information element of an enter-state attribute of the state machine model information set from which the state machine model information set instance invoking the ABI service is derived, when the set of states specified as an information element in the enter-state attribute contains the new nominated state being changed to or is an empty set.

48. An execution environment according to claim 43 wherein an ABI service of a data processing node is operable to change the current state of a state machine model information set instance to a new nominated current state, and is operable to execute the list of subroutine information sets specified by a subroutine list information element of an exit-state attribute of the state machine model information set from which the state machine model information set instance invoking the ABI service is derived, when the set of states specified as an information element in the exit-state contains the current state being changed from or is an empty set;

49. An execution environment according to claim 43 wherein the data processing node is additionally operable to execute a set of subroutine list information sets that have been simultaneously selected for execution in the order specified by the execution priority information element of each subroutine list information set.

50. An execution environment according to claim 43 wherein the data processing node is additionally operable to pass a notification message resulting from a registered subscription information set and posted to a hosted state machine model information set instance by the publish/subscribe messaging subsystem as an entry parameter to any subroutine information set whose execution the notifying message causes to be triggered.

51. An execution environment according to claim 43 wherein the load balancer subsystem is additionally operable to:
(a) receive message notifications resulting from subscriptions registered with the publish/subscribe messaging subsystem where the subscriptions specify a subscriber that is a state machine model information set, each notification comprising a message header which comprises at least one field specifying a job number
(b) direct a data processing node to create a new active instance of a state machine model information set the first time any job number is encountered within the header of a received message notification, where the state machine model information set is the subscriber to the received notification, and the initial received notification, as well as all subsequent received notifications that specify the newly encountered job number in their header are forwarded to the newly created state machine model information set instance;

52. An execution environment according to claim 43 wherein the load balancer subsystem is additionally operable to:
(a) receive message notifications resulting from subscriptions registered with the publish/subscribe messaging subsystem where the subscriptions specify a subscriber that is a state machine model information set, and
(b) direct a data processing node to create a new active instance of a state machine model information set the first time any message notification is received, where the state machine model information set is the subscriber to the received notification, and the initial received notification, as well as all subsequent received notifications for that state machine model information set are forwarded to the newly created state machine model information set instance.
